(19) United States
(12) Patent Application Publication
(10) Pub. No.: US 2021/0178700 A1
(43) Pub. Date: Jun. 17, 2021

(54) THREE-DIMENSIONAL SHAPING DEVICE AND THREE-DIMENSIONAL SHAPING METHOD

(71) Applicant: SEIKO EPSON CORPORATION, Tokyo (JP)

(72) Inventor: Akihiko TSUNOYA, OKAYA-SHI (JP)

(21) Appl. No.: 17/121,111

(22) Filed: Dec. 14, 2020

(30) Foreign Application Priority Data
Dec. 17, 2019 (JP) 2019-227278

(51) Int. Cl. B29C 64/393; B29C 64/35; B29C 64/245; B29C 64/209; B29C 64/295; B29C 64/232

(52) U.S. Cl. CPC B29C 64/393; B29C 64/35; B29C 64/245; B33Y 50/02; B29C 64/295; B29C 64/232; B29C 64/209

(57) ABSTRACT

A three-dimensional shaping device that shapes a three-dimensional shaped object by stacking a layer includes: a shaping table on which the three-dimensional shaped object and a quality control shaped object are shaped; an injecting unit configured to inject a shaping material of the three-dimensional shaped object and the quality control shaped object; a moving mechanism configured to move the shaping table and the injecting unit relatively to each other; monitoring units configured to monitor a shaping state of the quality control shaped object; and a control unit configured to control the injecting unit, the moving mechanism, and the monitoring units to form the layer. The injecting unit injects, onto the shaping table, the solid shaping material heated into a plasticized state under the control of the control unit, and the control unit forms the layer based on monitoring results of the monitoring units.

The present application is based on, and claims priority from JP Application Serial Number 2019-227278, filed Dec. 17, 2019, the disclosure of which is hereby incorporated by reference herein in its entirety.

### BACKGROUND

### 1. Technical Field

The present disclosure relates to a three-dimensional shaping device and a three-dimensional shaping method.

### 2. Related Art

In the related art, a three-dimensional shaping device that shapes a three-dimensional shaped object by stacking layers is used. In such a three-dimensional shaping device, it is required to shape a high-quality three-dimensional shaped object. For example, JP-A-2018-24196 discloses a data generation device that, after an evaluation shaped object is shaped before shaping an output shaped object as a three-dimensional shaped object to be shaped, corrects three-dimensional data of the output shaped object based on a measurement result of the evaluation shaped object.

However, when data of the three-dimensional shaped object is corrected as in the data generation device disclosed in JP-A-2018-24196, it takes time to correct the data, and productivity of the three-dimensional shaped object may decrease.

### SUMMARY

A three-dimensional shaping device according to the present disclosure for solving the above problems is a three-dimensional shaping device that shapes a shaped object by stacking a layer formed of a shaping material and includes: a shaping table on which a three-dimensional shaped object as the shaped object and a quality control shaped object are shaped; an injecting unit including a heating unit and configured to inject the shaping material that is plasticized; a moving mechanism configured to move the shaping table and the injecting unit relatively to each other; a monitoring unit configured to monitor a shaping state of the layer forming the quality control shaped object; and a control unit configured to control the injecting unit, the moving mechanism, and the monitoring unit to form the layer, in which the control unit forms the layer forming the three-dimensional shaped object based on a monitoring result of the monitoring unit.

### BRIEF DESCRIPTION OF THE DRAWINGS

FIG. 1 is a schematic front view showing a configuration of a three-dimensional shaping device according to an embodiment of the present disclosure.

FIG. 2 is a schematic perspective view showing a screw of the three-dimensional shaping device of FIG. 1.

FIG. 3 is a schematic plan view showing a state in which a shaping material is filled in the screw of the three-dimensional shaping device of FIG. 1.

FIG. 4 is a schematic plan view showing a barrel of the three-dimensional shaping device of FIG. 1.

FIG. 5 is a schematic perspective view showing an example of a three-dimensional shaped object to be shaped.

FIG. 6 is a schematic perspective view showing a state during formation of the three-dimensional shaped object of FIG. 5.

FIG. 7 is a schematic perspective view showing an example of a quality control shaped object in a preferred state.

FIG. 8 is a schematic perspective view showing an example of a quality control shaped object whose surface roughness is in a not preferred state.

FIG. 9 is a schematic perspective view showing an example of a quality control shaped object whose shape is in a not preferred state.

FIG. 10 is a diagram showing an example of a method of shaping the quality control shaped object using the three-dimensional shaping device of FIG. 1.

FIG. 11 is a flowchart of an example of a three-dimensional shaping method using the three-dimensional shaping device of FIG. 1.

### DESCRIPTION OF EXEMPLARY EMBODIMENTS

First, the present disclosure will be briefly described.

A three-dimensional shaping device according to a first aspect of the present disclosure for solving the above problems is provided, and the three-dimensional shaping device that shapes a shaped object by stacking a layer formed of a shaping material includes: a shaping table on which a three-dimensional shaped object as the shaped object and a quality control shaped object are shaped; an injecting unit including a heating unit and configured to inject the plasticized shaping material; a moving mechanism configured to move the shaping table and the injecting unit relatively to each other; a monitoring unit configured to monitor a shaping state of the layer forming the quality control shaped object; and a control unit configured to control the injecting unit, the moving mechanism, and the monitoring unit to form the layer, in which the control unit forms the layer forming the three-dimensional shaped object based on a monitoring result of the monitoring unit.

According to the present aspect, the layer is formed based on the monitoring result of the monitoring unit regarding the quality control shaped object. Therefore, it is possible to shape a high-quality three-dimensional shaped object. Data of the three-dimensional shaped object does not need to be corrected. Therefore, the high-quality three-dimensional shaped object can be shaped without decreasing productivity of the three-dimensional shaped object.

In the three-dimensional shaping device of a second aspect of the present disclosure according to the first aspect, the monitoring unit monitors, as the shaping state, a temperature of the layer forming the quality control shaped object formed on the shaping table, and the control unit forms the layer when the temperature is equal to or lower than a predetermined temperature.

When a next layer is formed before the plasticized shaping material solidifies, the three-dimensional shaped object to be shaped may deform. According to the present aspect, the temperature of the quality control shaped object monitored by the monitoring unit reaches the predetermined temperature, and then the next layer is formed. Therefore, the deformation of the three-dimensional shaped object caused by forming the next layer before the plasticized shaping material solidifies can be prevented.

In the three-dimensional shaping device of a third aspect of the present disclosure according to the first aspect or the second aspect, the monitoring unit monitors, as the shaping state, a shape of the layer forming the quality control shaped object formed on the shaping table, and the control unit forms the layer when the shape is within a predetermined range.

When the shape of the quality control shaped object is not a predetermined shape, it is highly possible that the shape of the three-dimensional shaped object to be shaped is not the desired shape. However, according to the present aspect, when the shape of the quality control shaped object monitored by the monitoring unit is not a predetermined shape, the formation of the next layer is stopped. Therefore, it is possible to prevent the continual formation of a three-dimensional shaped object having a high possibility of not having a desired shape.

In the three-dimensional shaping device of a fourth aspect of the present disclosure according to one aspect out of the first aspect to the third aspect, the monitoring unit monitors, as the shaping state, surface roughness of the layer forming the quality control shaped object formed on the shaping table, and the control unit forms the layer when the surface roughness is within a predetermined range.

According to the present aspect, it is possible to easily and accurately determine whether the shape of the quality control shaped object is a predetermined shape based on the surface roughness of the quality control shaped object.

In the three-dimensional shaping device of a fifth aspect of the present disclosure according to one aspect out of the first aspect to the third aspect, the monitoring unit monitors, as the shaping state, a color tone of a surface of the layer forming the quality control shaped object formed on the shaping table, and the control unit forms the layer when the color tone of the surface is smaller than a predetermined value.

According to the present aspect, when the color tone of the surface of the layer is monitored and the color tone of the surface of the layer is smaller than the predetermined value, the layer is formed. Therefore, it is possible to easily and accurately determine whether the shape of the quality control shaped object is a predetermined shape based on the color tone of the surface of the layer.

The three-dimensional shaping device of a sixth aspect of the present disclosure according to the third aspect to the fifth aspect further includes: a cleaning unit configured to clean the injecting unit, in which the control unit controls the moving mechanism and the injecting unit so as to clean the injecting unit by the cleaning unit when the shape or the surface roughness of the layer forming the quality control shaped object by the monitoring unit is not within the predetermined range.

According to the present aspect, when the shape of the quality control shaped object is not the predetermined shape, the injecting unit is cleaned by the cleaning unit. By cleaning the injecting unit, normal injection of the shaping material from the injecting unit can be recovered.

In the three-dimensional shaping device of a seventh aspect of the present disclosure according to one aspect out of the first aspect to the sixth aspect, the control unit moves the shaping table and the injecting unit relatively to each other in order to form quality control shaped portions forming the layer, and forms at least one of the quality control shaped portions when shaping the layer forming the quality control shaped object, and the control unit controls, when the at least one of the quality control shaped portions is not in a desired state as a result of the monitoring, the shaping table and the injecting unit so as to form a new quality control shaped portion that is not adjacent to the at least one of the quality control shaped portions.

According to the present aspect, a new quality control shaped portion is monitored by the monitoring unit so as not to be adjacent to the quality control shaped portion that is not in the desired state. When the monitoring unit monitors a portion where the quality control shaped portions are formed adjacently to each other, there is a concern that monitoring accuracy of the monitoring unit decreases, such as a decrease in accuracy of reading the shape, but such a concern can be prevented.

In the three-dimensional shaping device of an eighth aspect of the present disclosure according to one aspect out of the first aspect to the seventh aspect, the control unit moves the shaping table and the injecting unit relatively to each other in order to form quality control shaped portions forming the layer, and forms at least one of the quality control shaped portions when shaping the layer forming the quality control shaped object, and the control unit controls, when the at least one of the quality control shaped portions is in a desired state as a result of the monitoring, the shaping table and the injecting unit so as to form a plurality of new quality control shaped portions that are adjacent to the at least one of the quality control shaped portions to complete the layer.

According to the present aspect, by forming a plurality of quality control shaped portions forming the layer until the layer is completed, it is possible to secure a formation region of the quality control shaped portion in the new layer. There is a concern that the formation region of the quality control shaped portion becomes small due to the stacking, and the monitoring cannot be performed, but such a concern can be prevented.

In a three-dimensional shaping method according to a ninth aspect of the present disclosure of shaping a shaped object by stacking a layer formed of a shaping material, a three-dimensional shaping device includes a shaping table on which a three-dimensional shaped object as the shaped object and a quality control shaped object are shaped; an injecting unit including a heating unit and configured to inject the shaping material; a moving mechanism configured to move the shaping table and the injecting unit relatively to each other; and a monitoring unit configured to monitor a shaping state of the quality control shaped object, and the three-dimensional shaping method includes: forming the layer forming the three-dimensional shaped object based on a monitoring result of the monitoring unit.

According to the present aspect, the layer is formed based on the monitoring result of the monitoring unit regarding the quality control shaped object. Therefore, it is possible to shape a high-quality three-dimensional shaped object. Data of the three-dimensional shaped object does not need to be corrected. Therefore, the high-quality three-dimensional shaped object can be shaped without decreasing the productivity of the three-dimensional shaped object.

Hereinafter, an embodiment of the present disclosure will be described with reference to the accompanying drawings. The following drawings are all schematic diagrams, and a part of components are omitted or simplified. In the drawings, an X-axis direction is a horizontal direction, a Y-axis direction is a horizontal direction and is a direction orthogonal to the X-axis direction, and a Z-axis direction is a vertical direction.

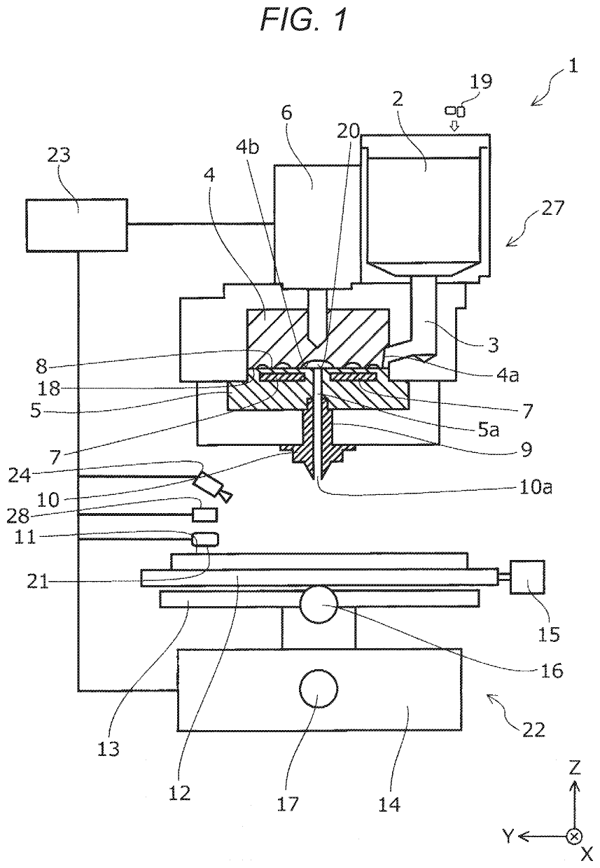

First, an overall configuration of a three-dimensional shaping device 1 according to an embodiment of the present disclosure will be described with reference to FIGS. 1 to 4. “Three-dimensional shaping” in the description refers to formation of a so-called three-dimensional object, and includes formation of a shape having a thickness of a so-called two-dimensional shape, such as a flat plate shape and a shape formed of, for example, one layer. “Support” includes, in addition to a case of supporting from a lower side, a case of supporting from a side and a case of supporting from an upper side depending on circumstances.

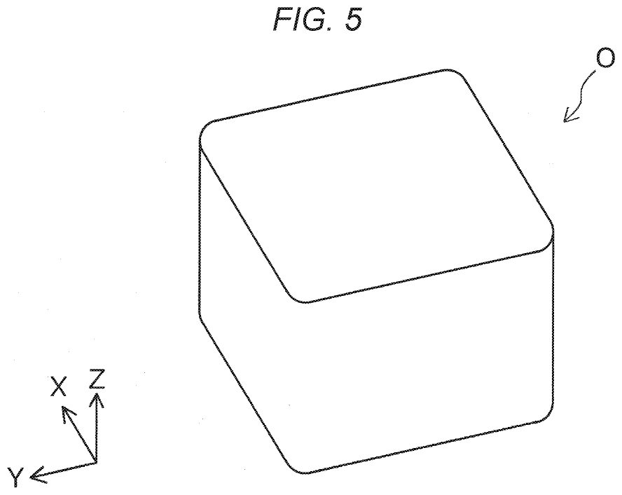

As shown in FIG. 1, the three-dimensional shaping device 1 according to the present embodiment includes a hopper 2 that accommodates a pellet 19 as a shaping material for shaping a three-dimensional shaped object O as shown in FIG. 5 to be described later. The pellet 19 accommodated in the hopper 2 is supplied, via a supply pipe 3, to a circumferential surface 4a of a screw 4 that is a substantially columnar flat screw. The three-dimensional shaping device 1 according to the present embodiment is configured to use the pellet 19 as the shaping material for shaping the three-dimensional shaped object O, and inject the shaping material while plasticizing the shaping material by the flat screw, but the present disclosure is not limited to the three-dimensional shaping device 1 having such a configuration. For example, the three-dimensional shaping device 1 may have a configuration in which a filament, which is a linear shaping material made of a resin, or a metal filament, in which a resin material is mixed with metal powder, is continuously injected while being melted to shape the three-dimensional shaped object O.

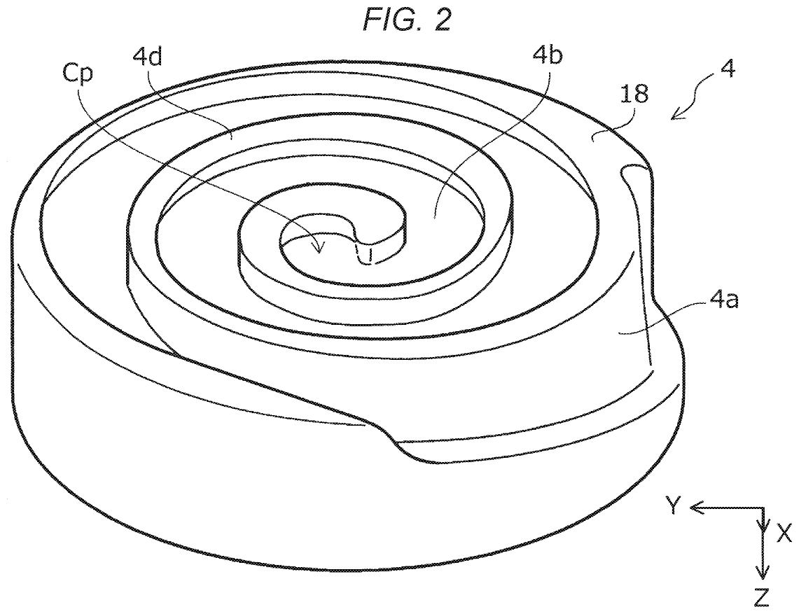

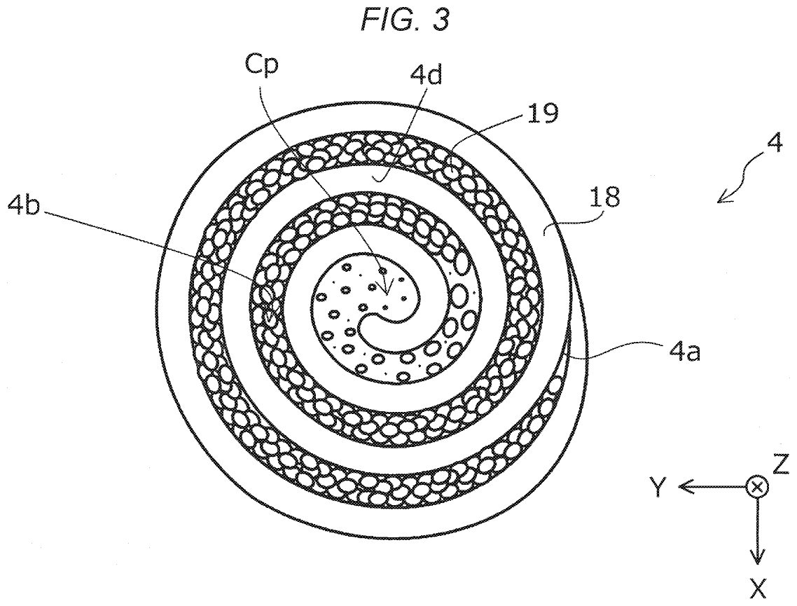

As shown in FIG. 2, a spiral groove 4b extending from the circumferential surface 4a to a central portion Cp is formed on a groove forming surface 18 that is a bottom surface of the screw 4. In other words, a rib 4d formed along with formation of the groove 4b forms the groove forming surface 18. Since the three-dimensional shaping device 1 according to the present embodiment has such a configuration, the screw 4 is rotated by a drive motor 6 shown in FIG. 1 with a direction along the Z-axis direction serving as a rotation axis, so that the pellet 19 is sent from the circumferential surface 4a to the central portion Cp as shown in FIG. 3. Although not shown in FIG. 1, cooling water is circulated in a vicinity of the drive motor 6 in order to prevent a temperature rise of the drive motor 6.

As shown in FIG. 1, a barrel 5 is provided at a position facing the groove forming surface 18 of the screw 4 with a predetermined interval. A thickness of the central portion Cp of the barrel 5 may be increased so that the interval decreases from a circumferential surface toward the central portion. A heating unit 7 is provided in a vicinity of a facing surface 8 with respect to the groove forming surface 18, which is an upper surface of the barrel 5. Since the screw 4 and the barrel 5 have such a configuration, the screw 4 is rotated to supply the pellet 19 into a space portion 20 that corresponds to a position of the groove 4b and is formed between the groove forming surface 18 of the screw 4 and the facing surface 8 of the barrel 5 and to move the pellet 19 from the circumferential surface 4a to the central portion Cp. When the pellet 19 is moved in the space portion 20 along the groove 4b, the pellet 19 is melted, that is, plasticized by heat of the heating unit 7, and is pressurized by a pressure accompanying the movement thereof in the narrow space portion 20. In this manner, the pellet 19 is plasticized and supplied to a nozzle 10a via a communication hole 5a, and is injected from the nozzle 10a.

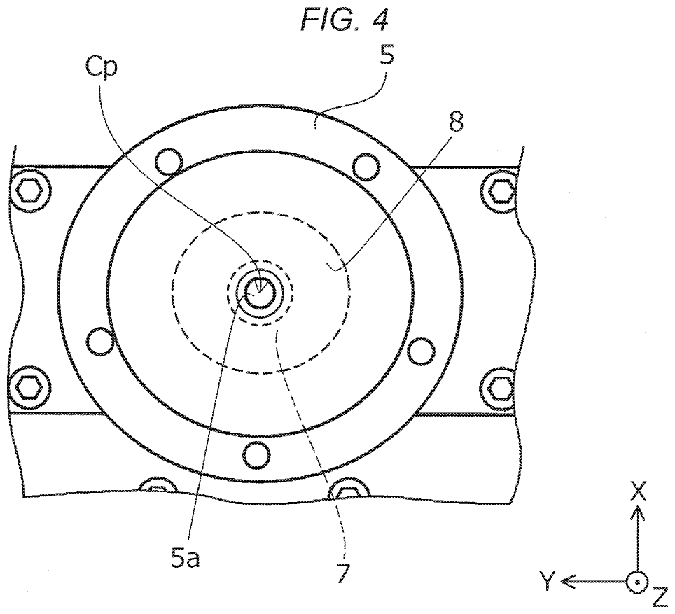

As shown in FIG. 4 and the like, the communication hole 5a that is a movement path of the melted pellet 19 is formed in the central portion Cp of the barrel 5 in a plan view. As shown in FIG. 1, the communication hole 5a is coupled to the nozzle 10a of an injecting unit 10 that injects the shaping material. A filter (not shown) is provided in the communication hole 5a. Although a groove is not formed in the barrel 5 according to the present embodiment, a groove coupled to the communication hole 5a may be formed on the facing surface 8 of the barrel 5. When the groove coupled to the communication hole 5a is formed on the facing surface 8, the shaping material may be easily collected toward the communication hole 5a.

Here, the injecting unit 10 can continuously inject the plasticized shaping material in a fluid state from the nozzle 10a. As shown in FIG. 1, the injecting unit 10 is provided with a heater 9 for heating the shaping material to a desired viscosity. The shaping material injected from the injecting unit 10 is injected in a linear shape. Then, a layer is formed by injecting the shaping material in a linear shape from the injecting unit 10.

The three-dimensional shaping device 1 according to the present embodiment includes an injection unit 27 including the hopper 2, the supply pipe 3, the screw 4, the barrel 5, the drive motor 6, and the injecting unit 10. The three-dimensional shaping device 1 according to the present embodiment is configured to include one injection unit 27 that injects the shaping material, but may be configured to include a plurality of injection units 27 that inject the shaping material, or may include an injection unit 27 that injects a support material. Here, the support material is a material for forming a layer of the support material for supporting a layer of the shaping material.

As shown in FIG. 1, the three-dimensional shaping device 1 according to the present embodiment includes a stage unit 22 for placing a layer of the shaping material to be formed by being injected from the injection unit 27. The stage unit 22 includes a plate 11 on which a layer of the shaping material is actually placed. The stage unit 22 includes a first stage 12 on which the plate 11 is placed and whose position can be changed along the Y-axis direction by driving a first drive unit 15. In addition, the stage unit 22 includes a second stage 13 on which the first stage 12 is placed and whose position can be changed along the X-axis direction by driving a second drive unit 16. Further, the stage unit 22 includes a base portion 14 that can change a position of the second stage 13 along the Z-axis direction by driving a third drive unit 17.

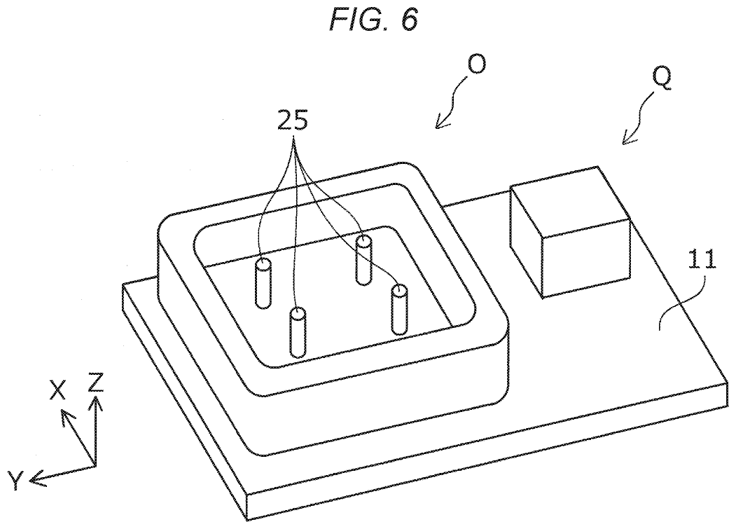

As shown in FIG. 1, the three-dimensional shaping device 1 according to the present embodiment is electrically coupled to a control unit 23 that controls various kinds of driving of the injection unit 27 and various kinds of driving of the stage unit 22. The components of the injection unit 27 and the stage unit 22 are driven under the control of the control unit 23. The control unit 23 is electrically coupled to a temperature sensor 21 for measuring a temperature of a quality control shaped object Q as shown in FIG. 6 to be described later, an imaging unit 24 for imaging the quality control shaped object Q, and a cleaning unit 28 for cleaning the injecting unit 10. The quality control shaped object Q is shaped by stacking layers as described later, and the layer is formed of a quality control shaped portion.

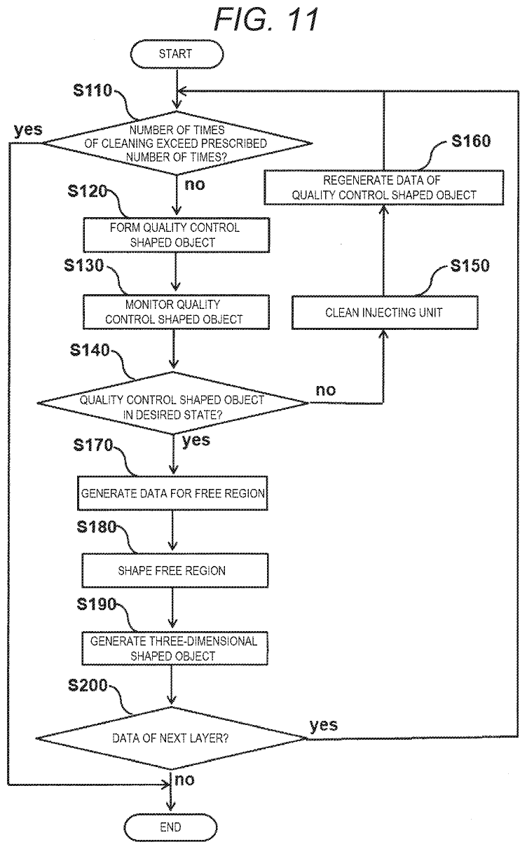

Next, an example of a three-dimensional shaping method executed using the three-dimensional shaping device 1 of FIG. 1 will be described with reference to a flowchart of FIG. 11 with reference to FIGS. 5 to 10. The flowchart of FIG. 11 is an example of the three-dimensional shaping method for shaping the three-dimensional shaped object O by stacking layers, but is a three-dimensional shaping method in which step S110 to step S190 represent a step of stacking one layer, and by repeating step S110 to step S190 in step S200 to stack layers, the three-dimensional shaped object O, for example, as shown in FIGS. 5 and 6 is shaped.

As shown in FIG. 11, in the three-dimensional shaping method according to the present embodiment, first, it is determined whether cleaning of the injecting unit 10 by the cleaning unit 28 exceeds a prescribed number of times after the shaping of the three-dimensional shaped object O is started. When the cleaning of the injecting unit 10 by the cleaning unit 28 exceeds the prescribed number of times, it is considered that recovery of the injecting unit 10 is not sufficient only by cleaning the injecting unit 10 by the cleaning unit 28. Therefore, since the cleaning unit 28 performs a processing including a maintenance processing other than cleaning in the injecting unit 10, the three-dimensional shaping method according to the present embodiment is ended. On the other hand, when the cleaning of the injecting unit 10 by the cleaning unit 28 does not exceed the prescribed number of times, the processing proceeds to step S120.

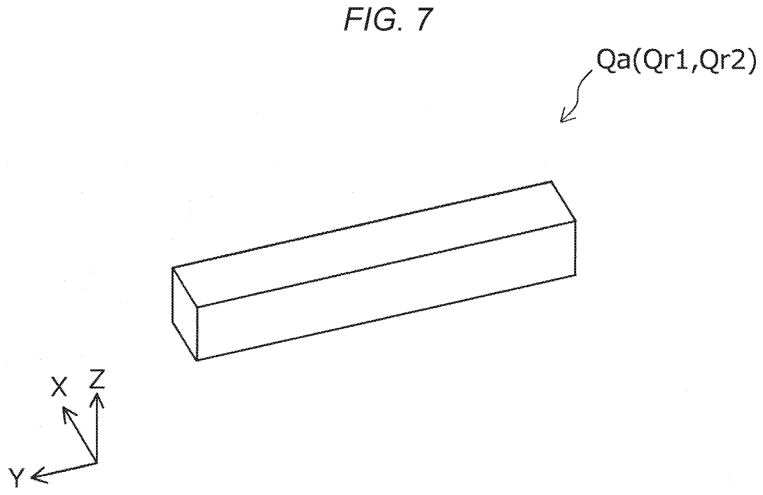

In step S120, the quality control shaped object Q is formed on the plate 11. In the present embodiment, when the quality control shaped object Q is formed on the plate 11, as shown in FIG. 6, the quality control shaped object Q is formed in a vicinity of a shaping position of the three-dimensional shaped object O to be shaped. However, the present disclosure is not limited to such a method. For example, a shaping place of the quality control shaped object Q may be provided at a place different from the plate 11 on which the three-dimensional shaped object O is shaped. The quality control shaped object Q may have various shapes depending on the shape of the three-dimensional shaped object O to be shaped. FIG. 7 is a quality control shaped portion Qa as a formed example of the quality control shaped object Q, which corresponds to a quality control shaped portion Qr1 and a quality control shaped portion Qr2 to be described later. In the three-dimensional shaping method according to the present embodiment, the quality control shaped portion Qr1 and the quality control shaped portion Qr2 have a rectangular parallelepiped shape whose longitudinal direction is the Y-axis direction. A time from step S120 to step S190 to be described later, that is, a time from the formation of the layer of the quality control shaped object Q to the formation of the layer of the three-dimensional shaped object O may be changed depending on whether formation positions of the quality control shaped object Q and the three-dimensional shaped object O are close or far to each other.

Next, in step S130, the quality control shaped object Q formed in step S120 is monitored. Specifically, a temperature of the quality control shaped object Q is monitored by the temperature sensor 21, and the quality control shaped object Q is imaged by the imaging unit 24. Here, a monitoring time, a monitoring timing, an imaging period, and an imaging timing of the quality control shaped object Q may be set by a user. For example, imaging is stopped during the time when the layer of the three-dimensional shaped object O is formed, and imaging is started at the same time when the shaping of the quality control shaped portion is started, so that a load of an image processing can be prevented from becoming heavy. Then, the processing proceeds to step S140, and the control unit 23 determines whether the quality control shaped object Q is in a desired state in step S140. Specifically, it is determined whether the temperature of the quality control shaped object Q is sufficiently lowered and whether there is no problem in the shape of the quality control shaped object Q.

A reason for confirming whether the temperature of the quality control shaped object Q is sufficiently lowered is as follows. In the three-dimensional shaping method according to the present embodiment, the quality control shaped object Q and the three-dimensional shaped object O are sequentially formed for each layer. That is, when the three-dimensional shaped object O is formed by stacking two or more layers, if the temperature of the quality control shaped object Q is sufficiently lowered in a certain layer, a temperature of a lower layer, which is a previously formed layer of the three-dimensional shaped object O, is also sufficiently lowered. If the temperature of the lower layer of the three-dimensional shaped object O is not sufficiently lowered, there is a concern that the lower layer is deformed when an upper layer is formed, but if the temperature of the lower layer of the three-dimensional shaped object O is sufficiently lowered, the concern that the lower layer is deformed when the upper layer is formed can be reduced. Although the temperature of the quality control shaped object Q is monitored by the temperature sensor 21 in the present embodiment, the temperature of the quality control shaped object Q can also be monitored based on a color of the quality control shaped object Q imaged by the imaging unit 24, for example.

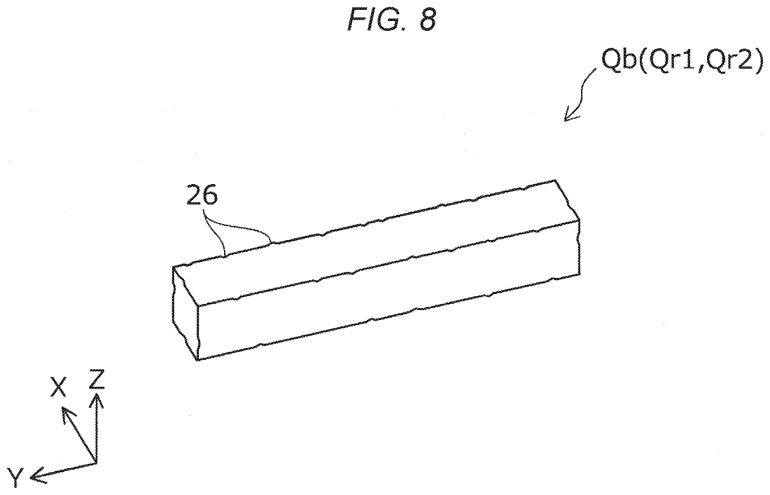

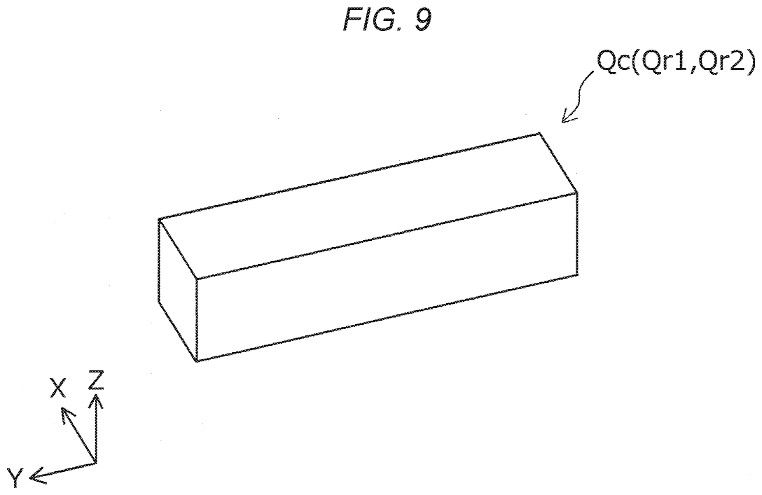

The reason for confirming that there is no problem in the shape of the quality control shaped object Q is to increase a probability that an internal shape can be shaped with high accuracy, for example, when the three-dimensional shaped object O has a characteristic internal shape that cannot be confirmed from the outside after completion, such as a pin 25 provided inside the three-dimensional shaped object O, as shown in FIGS. 5 and 6. For example, it is assumed that the quality control shaped object Q having a preferred shape formed based on shaping data of the quality control shaped object Q is the quality control shaped portion Qa as shown in FIG. 7. When the quality control shaped object Q actually shaped is formed to have unevenness 26 on a surface like a quality control shaped portion Qb shown in FIG. 8, or when the quality control shaped object Q actually shaped is formed to be larger than a desired size like a quality control shaped portion Qc shown in FIG. 9, there is a concern that the internal shape of the completed three-dimensional shaped object O is defective. This is because, when there is the unevenness 26 on the surface, an injection amount is often insufficient, and when the quality control shaped portion is formed to be larger than a desired size, the injection amount is often excessive. Therefore, by monitoring the quality control shaped object Q to determine whether the quality control shaped object Q is in a desired state, it is possible to prevent the formation of the three-dimensional shaped object O having a defect in the internal shape even when the three-dimensional shaped object O is formed in a shape that it is not known whether the completed three-dimensional shaped object O has a defect in the internal shape when only viewed from the outside. The imaging unit 24 in the present embodiment is configured to perform observation at a fixed point, but is not limited to such a configuration.

In the three-dimensional shaping method according to the present embodiment, although the quality control shaped object Q is monitored from the two viewpoints: the temperature of the quality control shaped object Q and the shape of the quality control shaped object Q, either one may be monitored, or the quality control shaped object Q may be monitored from other viewpoints. In the three-dimensional shaping method according to the present embodiment, the quality control shaped object Q is first formed in step S120 in each layer, and then the three-dimensional shaped object O is formed in step S190 to be described later, but the three-dimensional shaped object O may be formed before the quality control shaped object Q is formed, or the quality control shaped object Q and the three-dimensional shaped object O may be simultaneously formed in accordance with contents of the monitoring.

When it is determined in step S140 that the quality control shaped object Q is in the desired state, the processing proceeds to step S170, and when it is determined in step S140 that the quality control shaped object Q is not in the desired state, the processing proceeds to step S150. Here, in step S150, the injecting unit 10 is cleaned by the cleaning unit 28, and thereafter, the processing proceeds to step S160 to regenerate the shaping data of the quality control shaped object Q, and the processing returns to step S110.

In step S170, in preparation for forming the next layer of the quality control shaped object Q, data for forming a free region S for forming the quality control shaped object Q is generated. Then, in step S180, the free region S is formed based on the data generated in step S170.

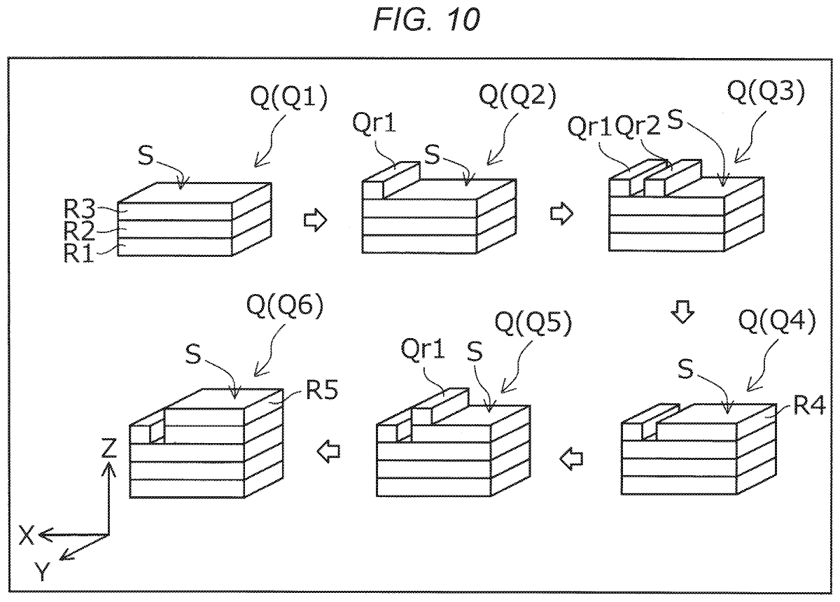

Here, the formation of the free region S will be described with reference to FIG. 10. In FIG. 10, quality control shaped objects Q1 to Q6 represent the whole image of the quality control shaped object Q, as shown in FIG. 6. On the other hand, the quality control shaped portions Qr1 and Qr2 represent portions to be monitored in step S130 in the quality control shaped object Q, as shown in FIGS. 7 to 9.

The quality control shaped object Q1 represents a state in which a first layer R1 to a third layer R3 are stacked. In other words, the steps from step S110 to step S190 to be described later are repeated three times in step S200, and step S120 for the fourth time is about to be executed. In the quality control shaped object Q1, all the regions on the layer R3 are free regions S. The layers from the first layer R1 to the third layer R3 are stacked in a desired state.

The quality control shaped object Q2 represents a state in which the quality control shaped portion Qr1 in a fourth layer R4 is formed in the free region S on the layer R3. However, it is assumed that the quality control shaped portion Qr1 is determined not to be in a desired state in step S140. Then, in the next step S120 through step S150 and step S160, the quality control shaped portion Qr2 is formed next to the quality control shaped portion Qr1 at an interval in the free region S on the layer R3, as represented by the quality control shaped object Q3.

Here, it is assumed that the quality control shaped portion Qr2 is determined to be in a desired state in step S140. Then, the processing proceeds to step S170 and step S180, and as represented by the quality control shaped object Q4, the shaping material is injected to be adjacent to the quality control shaped portion Qr2 to shape the free region S on the layer R4.

Thereafter, as represented by the quality control shaped object Q5, the quality control shaped portion Qr1 is formed in the free region S on the layer R4 in step S120 with respect to a fifth layer R5. Here, it is assumed that the quality control shaped portion Qr1 is determined to be in a desired state in step S140. Then, the processing proceeds to step S170 and step S180, and as represented by the quality control shaped object Q6, the shaping material is injected to be adjacent to the quality control shaped portion Qr1 to shape the free region S on the layer R5. Then, such processing is repeated.

After the free region S is formed in step S180, the three-dimensional shaped object O is formed in step S190. In the present embodiment, the three-dimensional shaped object O having the same number of layers as the number of layers in which the free region S is formed in the quality control shaped object Q is formed. That is, the quality control shaped object Q and the three-dimensional shaped object O are alternately formed one layer at a time. However, the present disclosure is not limited to such an example. For example, after one layer of the quality control shaped object Q is formed and the layer is monitored to be confirmed that there is no problem, a plurality of layers of the three-dimensional shaped object O may be formed and these operations may be repeated. Further, the quality control shaped object Q may be sequentially formed individually in the free region of the plate 11, or the quality control shaped object Q may not have a stacked structure as shown in FIG. 10.

Then, the processing proceeds to step S200, where the control unit 23 determines whether there is shaping data of the three-dimensional shaped object O and the quality control shaped object Q of the next layer. When it is determined in step S200 that there is the next layer, the processing returns to step S110, and when it is determined that there is no next layer, the three-dimensional shaping method according to the present embodiment is ended.

Here, in summary, the three-dimensional shaping device 1 according to the present embodiment is a three-dimensional shaping device that shapes the three-dimensional shaped object O by stacking layers, which includes: the plate 11 as a shaping table on which the three-dimensional shaped object O and the quality control shaped object Q are shaped; the injecting unit 10 configured to inject the solid pellet 19 heated into a plasticized state, which is the shaping material of the three-dimensional shaped object O and the quality control shaped object Q; the stage unit 22 as the moving mechanism configured to move the plate 11 and the injecting unit 10 relatively to each other; and the temperature sensor 21 and the imaging unit 24 as the monitoring unit configured to monitor a shaping state of the quality control shaped object Q. Then, under the control of the control unit 23, the three-dimensional shaping method of forming the layer can be executed based on the monitoring result of the temperature sensor 21 and the imaging unit 24.

Thus, the three-dimensional shaping device 1 according to the present embodiment forms the layer based on the monitoring result of the temperature sensor 21 and the imaging unit 24 regarding the quality control shaped object Q. Therefore, it is possible to shape a high-quality three-dimensional shaped object O. Shaping data of the three-dimensional shaped object O does not need to be corrected. Therefore, the high-quality three-dimensional shaped object can be shaped without decreasing productivity of the three-dimensional shaped object O.

Here, the temperature sensor 21 as the monitoring unit monitors, as the shaping state of the quality control shaped object Q, the temperature of the quality control shaped object Q formed on the plate 11. Then, when the control unit 23 executes step S140, the temperature of the quality control shaped object Q monitored by the temperature sensor 21 reaches a predetermined temperature and then the layer of the three-dimensional shaped object O can be formed. When a next layer is formed before the plasticized shaping material solidifies, the three-dimensional shaped object to be shaped may deform. However, according to the three-dimensional shaping device 1 according to the present embodiment, the temperature of the quality control shaped object Q monitored by the temperature sensor 21 reaches the predetermined temperature, and then the next layer is formed. Therefore, the deformation of the three-dimensional shaped object O caused by forming the next layer before the plasticized shaping material solidifies can be prevented. A contact-type thermometer, an infrared thermography, a radiation thermometer, or the like can be used as the monitoring unit.

The imaging unit 24 as the monitoring unit monitors, as the shaping state, the shape of the quality control shaped object Q formed on the plate 11 or the previously formed layer forming the quality control shaped object Q. In a case where the control unit 23 executes step S140, the shape of the quality control shaped object Q monitored by the imaging unit 24 is a preferred predetermined shape, the layer of the three-dimensional shaped object O can be formed, and when the shape of the quality control shaped object Q monitored by the imaging unit 24 is not a preferred predetermined shape, the formation of the layer of the three-dimensional shaped object O can be stopped. When the shape of the quality control shaped object Q is not a predetermined shape, it is highly possible that a shape of the three-dimensional shaped object O to be shaped is also not a desired shape. However, according to the three-dimensional shaping device 1 according to the present embodiment, when the shape of the quality control shaped object Q monitored by the imaging unit 24 is not a predetermined shape, the formation of the next layer can be stopped. For example, when a linear quality control shaped portion, formed on the plate 11 or the previously formed layer forming the quality control shaped object Q by discharging the shaping material from the nozzle 10a in one scan, is out of a range of a line width specified by the shaped object, the formation of the next layer is stopped. Therefore, it is possible to prevent the formation of the three-dimensional shaped object O having a high possibility of not having a desired shape. A non-contact laser microscope, a laser length measuring system, a stylus profiler, or the like can be used as the monitoring unit.

In addition, the monitoring unit can image surface roughness of the quality control shaped object Q as the shaping state of the quality control shaped object Q. Therefore, according to the three-dimensional shaping device 1 according to the present embodiment, it is possible to easily and accurately determine whether the shape of the quality control shaped object Q is a predetermined shape based on the surface roughness of the quality control shaped object Q. For example, when a linear quality control shaped portion, formed on the plate 11 or the previously formed layer forming the quality control shaped object Q by discharging the shaping material from the nozzle 10a in one scan, has a surface roughness Ra out of a range from Ra 5 μm to Ra 50 μm, the formation of the next layer is stopped. A stylus profiler, an atomic force microscope, or the like can be used as the monitoring unit.

In addition, the monitoring unit can measure a color tone of the quality control shaped object Q as the shaping state of the quality control shaped object Q. Therefore, according to the three-dimensional shaping device 1 according to the present embodiment, it is possible to easily and accurately determine whether the shaping state of the quality control shaped object Q has a predetermined color tone based on the color tone of the quality control shaped object Q. For example, when a linear quality control shaped portion, formed on the plate 11 or the previously formed layer forming the quality control shaped object Q by discharging the shaping material from the nozzle 10a in one scan, has a color difference ΔE value greater than 1.0 based on a color value of a surface of the linear quality control shaped portion that is injected in a normal injection state, the formation of the next layer is stopped. A spectral colorimeter, achromatic color difference meter, a color luminance meter, or the like can be used as the monitoring unit.

The three-dimensional shaping device 1 according to the present embodiment includes the cleaning unit 28 for cleaning the injecting unit 10. When the shape of the quality control shaped object Q monitored by the imaging unit 24 is not a preferred predetermined shape as, for example, the quality control shaped object Qb of FIG. 8 and the quality control shaped portion Qc of FIG. 9, the control unit 23 can control the cleaning unit 28 to clean the injecting unit 10. In the three-dimensional shaping device according to the present embodiment, when the shape of the quality control shaped object Q is not a preferred predetermined shape, the injecting unit 10 is cleaned by the cleaning unit 28, so that normal injection of the shaping material from the injecting unit 10 can be recovered by cleaning the injecting unit 10.

Here, the control unit 23 in the present embodiment can form each of the layers to be stacked by reciprocating the plate 11 and the injecting unit 10 relatively to each other a plurality of times. In other words, the three-dimensional shaping device 1 according to the present embodiment forms each layer in a plurality of passes under the control of the control unit 23. Since the three-dimensional shaping device 1 according to the present embodiment has such a configuration, the three-dimensional shaped object O can be shaped with high accuracy while reducing the number of injecting units 10 that tend to be high in cost.

As shown in FIG. 10, when shaping the quality control shaped object Q, under the control of the control unit 23, the three-dimensional shaping device 1 according to the present embodiment monitors, by the temperature sensor 21 and the imaging unit 24, portions (for example, the quality control shaped portion Qr2 formed so as not to be adjacent to the quality control shaped portion Qr1) formed so as not to be adjacent in the X-axis direction intersecting the Y-axis direction, which is a direction of a reciprocating movement when viewed from a stacking direction along the Z-axis direction. When the temperature sensor 21 and the imaging unit 24 monitor the portion where paths are formed adjacently to each other, there is concern that monitoring accuracy of the temperature sensor 21 and the imaging unit 24 decreases, such as a decrease in accuracy of reading the shape, but such a concern can be prevented by the three-dimensional shaping device 1 according to the present embodiment.

The present disclosure is not limited to the embodiment described above, and can be implemented in various configurations without departing from the scope of the disclosure. In order to solve some or all of problems described above, or to achieve some or all of effects described above, technical features in the embodiment corresponding to technical features in aspects described in the summary can be replaced or combined as appropriate. The technical features can be deleted as appropriate unless the technical features are described as essential in the present description.

What is claimed is:

1. A three-dimensional shaping device that shapes a shaped object by stacking a layer formed of a shaping material, the three-dimensional shaping device comprising:
a shaping table on which a three-dimensional shaped object as the shaped object and a quality control shaped object are shaped;
an injecting unit including a heating unit and configured to inject the shaping material that is plasticized;
a moving mechanism configured to move the shaping table and the injecting unit relatively to each other;
a monitoring unit configured to monitor a shaping state of the layer forming the quality control shaped object; and
a control unit configured to control the injecting unit, the moving mechanism, and the monitoring unit to form the layer, wherein
the control unit forms the layer forming the three-dimensional shaped object based on a monitoring result of the monitoring unit.

2. The three-dimensional shaping device according to claim 1, wherein
the monitoring unit monitors, as the shaping state, a temperature of the layer forming the quality control shaped object formed on the shaping table, and
the control unit forms the layer when the temperature is equal to or lower than a predetermined temperature.

3. The three-dimensional shaping device according to claim 1, wherein
the monitoring unit monitors, as the shaping state, a shape of the layer forming the quality control shaped object formed on the shaping table, and
the control unit forms the layer when the shape is within a predetermined range.

4. The three-dimensional shaping device according to claim 1, wherein
the monitoring unit monitors, as the shaping state, surface roughness of the layer forming the quality control shaped object formed on the shaping table, and
the control unit forms the layer when the surface roughness is within a predetermined range.

5. The three-dimensional shaping device according to claim 1, wherein
the monitoring unit monitors, as the shaping state, a color tone of a surface of the layer forming the quality control shaped object formed on the shaping table, and
the control unit forms the layer when the color tone of the surface is smaller than a predetermined value.

6. The three-dimensional shaping device according to claim 3, further comprising:
a cleaning unit configured to clean the injecting unit, wherein
the control unit controls the moving mechanism and the injecting unit so as to clean the injecting unit by the cleaning unit when the shape or the surface roughness of the layer forming the quality control shaped object monitored by the monitoring unit is not within the predetermined range.

7. The three-dimensional shaping device according to claim 1, wherein
the control unit moves the shaping table and the injecting unit relatively to each other in order to form quality control shaped portions forming the layer, and forms at least one of the quality control shaped portions when shaping the layer forming the quality control shaped object, and
the control unit controls, when the at least one of the quality control shaped portions is not in a desired state as a result of the monitoring, the shaping table and the injecting unit so as to form a new quality control shaped portion that is not adjacent to the at least one of the quality control shaped portions.

8. The three-dimensional shaping device according to claim 1, wherein
the control unit moves the shaping table and the injecting unit relatively to each other in order to form quality control shaped portions forming the layer, and forms at least one of the quality control shaped portions when shaping the layer forming the quality control shaped object, and
the control unit controls, when the at least one of the quality control shaped portions is in a desired state as a result of the monitoring, the shaping table and the injecting unit so as to form a plurality of new quality control shaped portions that are adjacent to the at least one of the quality control shaped portions to complete the layer.

9. A three-dimensional shaping method of shaping a shaped object by stacking a layer formed of a shaping material, a three-dimensional shaping device including
a shaping table on which a three-dimensional shaped object as the shaped object and a quality control shaped object are shaped,
an injecting unit including a heating unit and configured to inject the shaping material,
a moving mechanism configured to move the shaping table and the injecting unit relatively to each other, and
a monitoring unit configured to monitor a shaping state of the quality control shaped object,
the three-dimensional shaping method comprising:
forming the layer forming the three-dimensional shaped object based on a monitoring result of the monitoring unit.
